(19) United States
(12) Patent Application Publication
(10) Pub. No.: US 2003/0064772 A1
(43) Pub. Date: Apr. 3, 2003

(54) Gaming device and method

(76) Inventors: Kim Tempest, Las Vegas, NV (US); Jon Leupp, Las Vegas, NV (US)

Correspondence Address: Bernhard Kreten, Suite 245, 77 Cadillac Drive, Sacramento, CA, 95825, US

(21) Appl. No.: 09/967,512

(22) Filed: Sep. 28, 2001

(51) Int. Cl. A63F 13/00

(52) U.S. Cl. 463/16

(57) ABSTRACT

A method and device for gaming, in which a primary game is played consisting of plural concurrent gaming propositions. The player is free to select which of the plural propositions is to be played, usually by wager magnitude. The primary game leads to a secondary game. The secondary game includes a “mechanism” which periodically changes throughout several wagers. Additionally, the primary and/or secondary game contains at least one outcome that leads to a separate bonus game.

### FIELD OF THE INVENTION

The following invention is generally related to instrumentalities and methodologies in gaming devices. More specifically, the instant invention is directed to a method and apparatus for playing a primary game and secondary game in which the two types of games are interrelated and played concurrently. Such a game includes a “mechanism” to periodically modify the gaming environment, so as to produce a varied experience throughout multiple gaming sessions. The opportunity to participate in a separate bonus game is also available.

### BACKGROUND OF THE INVENTION

Technology advances have made it possible to produce a variety of elaborate games that may be played in a casino environment. For the most part, however, most gaming machines are representative of traditional reel-type games, using either actual mechanical reels or video depictions of such reels for display. While the familiarity of reel-type games may initially attract players, an absence of different stimuli prevents players for remaining at any particular game for an extended time period. Additional games offered by such machines, providing active modes of play, would be much more effective at attracting new players and at retaining their interest for prolonged periods.

### SUMMARY OF THE INVENTION

The present invention is distinguishable over the prior art in that the gaming premise is intuitive and the game is easy to understand. The action of the game and the presence of easily recognizable themes contributes to the excitement and level of stimulation available.

At its fundamental level, the device according to the present invention provides a primary game that combines conventional reel-type games with secondary BINGO-style games. The reels contain symbols, which may directly provide winning outcomes for the reel game according to a paytable. Additionally, special BINGO ball symbols are present on the reels. Some of these balls animate to display values, which may correspond to the numbered positions on the BINGO card. The number of BINGO balls that animate is dependent on the magnitude of the wager deposited by the player. More balls animate, or are “enabled,” if the player deposits a larger wager. If the value displayed on the ball matches a position on the BINGO card, the space is marked. Play continues, with the object being to cover, on a 5×5 matrix, five spaces in a row, whether diagonally, horizontally, or vertically.

Filling the BINGO card is time/play dependant. After a predetermined number of BINGO balls have revealed values (or using other criteria, such as number/magnitude of wager), the numbered positions on the BINGO card are “shifted up” one row, with the top row disappearing and a new row of randomly-numbered positions appearing at the bottom. Any marked positions that remain on the card after the move remain marked and available for player enrichment based on achieving “BINGO” (5 in a series). Any values corresponding to marked positions in the disappearing row are returned to the pool of available values and are no longer selected for potential player enrichment. Because less than maximum wagers do not “enable” all BINGO ball to become eligible to move from the reel to the BINGO card, and because the BINGO card “shifts” (changes) a player is encouraged to enable maximum BINGO balls via a maximum wager.

A separate bonus game is activated by the appearance of special bonus symbols in a particular configuration preferably from the reels but also perhaps from the BINGO card. A new BINGO card appears, containing differently-numbered positions than the card in the secondary game. A multiplicity of BINGO balls are displayed in a matrix, along with a randomly generated number of “spins” available to the player. Each spin causes the balls to animate and display (reveal) values to be matched to the positions on the bonus BINGO card. The object is to match as many positions as possible on this bonus card. After all allotted spins have been exhausted, a bonus award is calculated, and the player may earn multipliers for that award by attaining special outcomes on the bonus card. At the conclusion of the bonus game, the player is returned to the primary game. The BINGO card from the secondary game is in the same state as it was before the beginning of the bonus game.

### OBJECTS OF THE INVENTION

Accordingly, it is a primary object of the present invention to provide a new and novel device and method for gaming.

It is a further object of the present invention to provide a device and method as characterized above in which a player has the opportunity to play a secondary game for more chances at success.

It is a further object of the present invention to provide a device and method as characterized above which provides a player with the prospect of engaging in different types of gaming propositions concurrently in one gaming session.

It is a further object of the present invention to provide a device and method as characterized above which is intuitive to use and has eye appeal.

It is a further object of the present invention to provide a device and method as characterized above which simulates familiar themes.

It is a further object of the present invention to provide a device and method as characterized above which offers a variety of games for greater stimulation.

It is a further object of the present invention to provide a device and method as characterized above to allow the player to increase the chance of winning by placing additional wagers, which affect the total number of favorable outcomes available.

Viewed from a first vantage point, it is an object of the present invention to provide a device for gaming, comprising, in combination: a display, a wagering means and a processor operatively coupled to said display and activated by said wagering means, said display when enabled including a primary game, said primary game including means for modifying said primary game during play and as a function of play.

Viewed from a second vantage point, it is an object of the present invention to provide a method for gaming, the steps including: receiving a wager, enabling a display upon receipt of the wager, playing a primary game, said primary game having an outcome, applying a subset of said primary game outcomes to a secondary game, and modifying the play of said secondary game as a function of said primary game outcomes.

These and other objects will be made manifest when considering the following detailed specification when taken in conjunction with the appended drawing figures.

### BRIEF DESCRIPTION OF THE DRAWINGS

FIG. 1 is a flowchart of the methodology according to the present invention.

FIG. 2 is a depiction of the apparatus associated therewith.

FIG. 3 is a depiction of a primary game, depicting a primary row and column (RXC) matrix located above a plurality of randomly-numbered positions in a secondary row and column (RXC) matrix.

FIG. 4 is a depiction of the play of the primary game.

FIG. 5 is depiction of the “scrolling up” action on the secondary game.

FIG. 6 is a depiction of a winning outcome and screen on the secondary game.

FIG. 7 is a depiction of a bonus game welcome screen.

FIG. 8 is a depiction of a bonus game screen during play.

### DESCRIPTION OF PREFERRED EMBODIMENTS

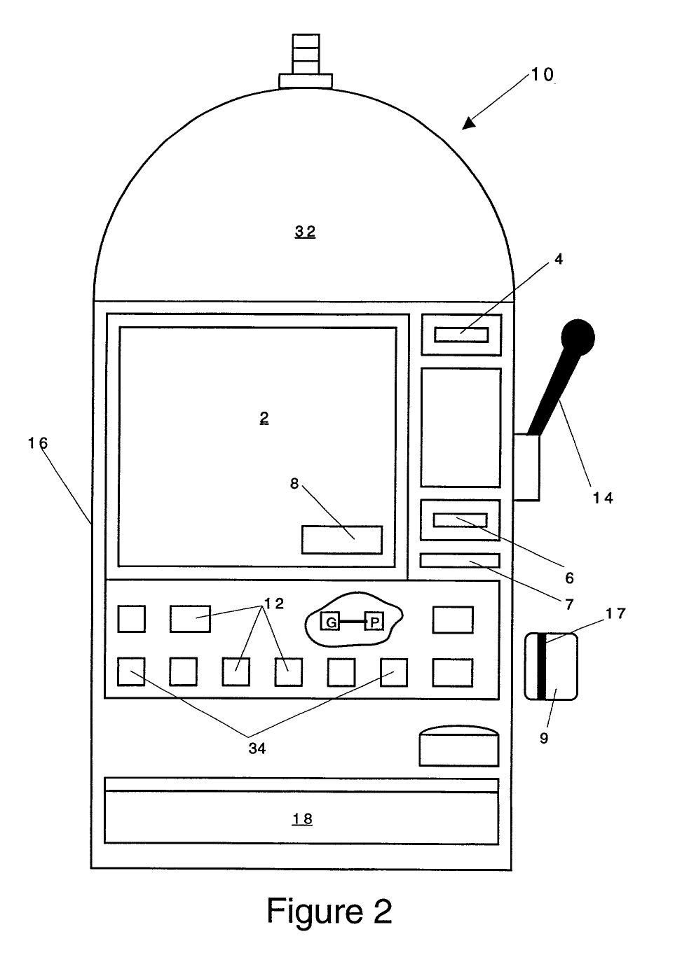

Considering the drawings, wherein like reference numerals denote like parts throughout the various drawing figures, reference numeral 10 as shown in FIG. 2 is directed to the device according to the present invention.

In its essence, the device 10 includes a housing 16 which supports a visual display 2, preferably a video monitor, therewithin. The display 2 may include a window 8 for special messages or for incrementing counting of credits accumulated by the player. The device also includes an LED or other readout 4 for prompting the player and can provide similar verbiage as the window 8 or in lieu thereof, to stimulate the player. The device includes an inlet 6 for the reception therein for coins, currency or the like to auger in the inception of play. A plurality of decision-making buttons 12 are located on the face of the apparatus 10, preferably below the display 2, and a pull handle 14 can be used to initiate play as an alternative to supplement the decision-making buttons 12. A coin hopper 18 or other payment methods, i.e., ticket printers, may be included to effectuate an output of an award due the player. The device 10 may have a top portion 32 with a display thereon having a motif correlative with the game to be played and can include a paytable. A plurality of speakers 34 may be included on the device for aural interaction with the player. The apparatus also includes a processor P coordinating all functions and a random number generator G operatively coupled thereto for generating outcomes. A card 9, having a read/write instrumentality 17 thereon, can be read via input 7 as a substitute for or supplement to credit transfers as well as player identification.

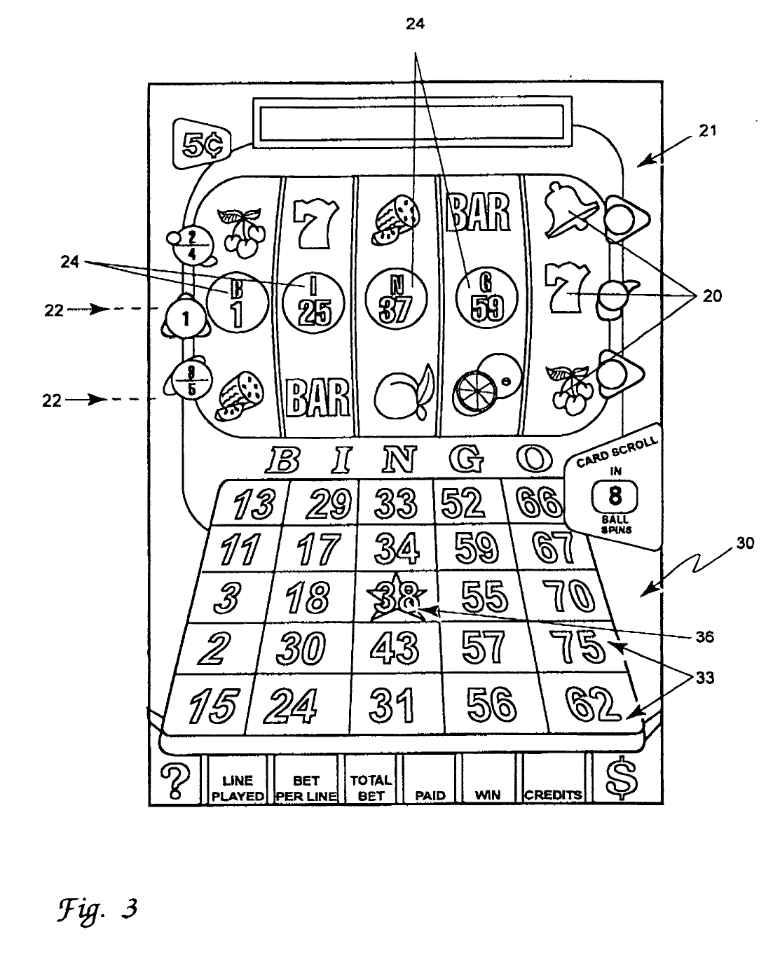

More specifically, and with reference to FIG. 3, greater details with respect to the video display 2 can be explored. The display 2 features a plurality of symbols 20 arranged in a primary row and column (RXC) matrix 21, corresponding to a primary game. Paylines 22 correspond to areas on the primary matrix 21 in which winning combinations may be located. The primary game is preferably a reel-type game, well known in the art, with multiple paylines, displaying three rows on five reels (a 3×5 matrix) and having 5, 9, 15, or 25 paylines. Below the primary matrix 21, the display 2 features a plurality of randomly-numbered positions 33 in a secondary row and column (RXC) matrix 30. This defines a secondary game. Numbers for play by the device are randomly generated for play on the matrix 30. Preferably, the matrix defines a 5×5 array, correlative of BINGO, and above row one depicts the letters “BINGO,” defining with positions 33 an alphanumeric display.

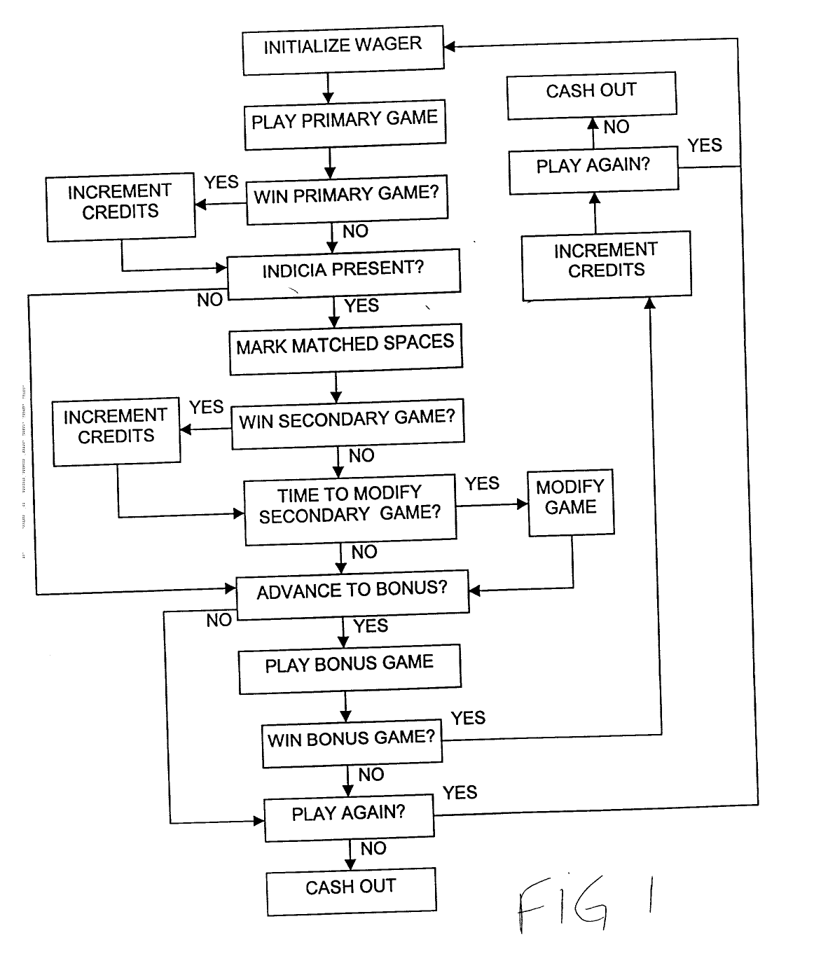

Referring to FIG. 1, the flow chart associated with the apparatus of FIGS. 2 and 3 can be explored. Initially, the display is shown in with a primary game matrix 21 positioned above a secondary game matrix 30. Initially, a player makes a wager to initialize the game. The player then engages in a gaming proposition on the primary game matrix 21 for which rewards are given for specific outcomes according to a paytable. For example three to five cherries appear on a payline and is recognized as a winning outcome on a paytable. Primary indicia in FIG. 3 use numeral 20.

In addition to indicia 20 that produce winning outcomes directly on the primary game matrix 21, the primary game also contains secondary indicia 24 that only relate to the secondary game, such as BINGO balls each of which has one letter (e.g. B, I, N, G, O) and a numeral. In one form of the invention the ball's value is hidden. The secondary game is played on the secondary game matrix 30, representative of a BINGO card. Assume a player makes less than a maximum bet. Each secondary indicium 24 may reveal a value correlative of a possible value on the secondary game matrix 30, in other words a match. Indicia that are “enabled” by a bet of appropriate magnitude animate after appearing on the primary game matrix 21, spinning 180° to reveal its a numeric or alphanumeric value leading to an award. If indicia appear that are not “enabled,” a message appears, prompting the player to deposit additional wagers to enable more indicia, and play continues. Thus, the gaming proposition shows the player it is not fully capable of making an award with less than a maximum bet, but still shows the potential benefit to a patron. Preferably for games played with a maximum wager, all indicia are enabled. Games played with less than a maximum wager may have a subset of enabled indicia, or may not enable any indicia at all. Clearly the incentive is to encourage maximum bets.

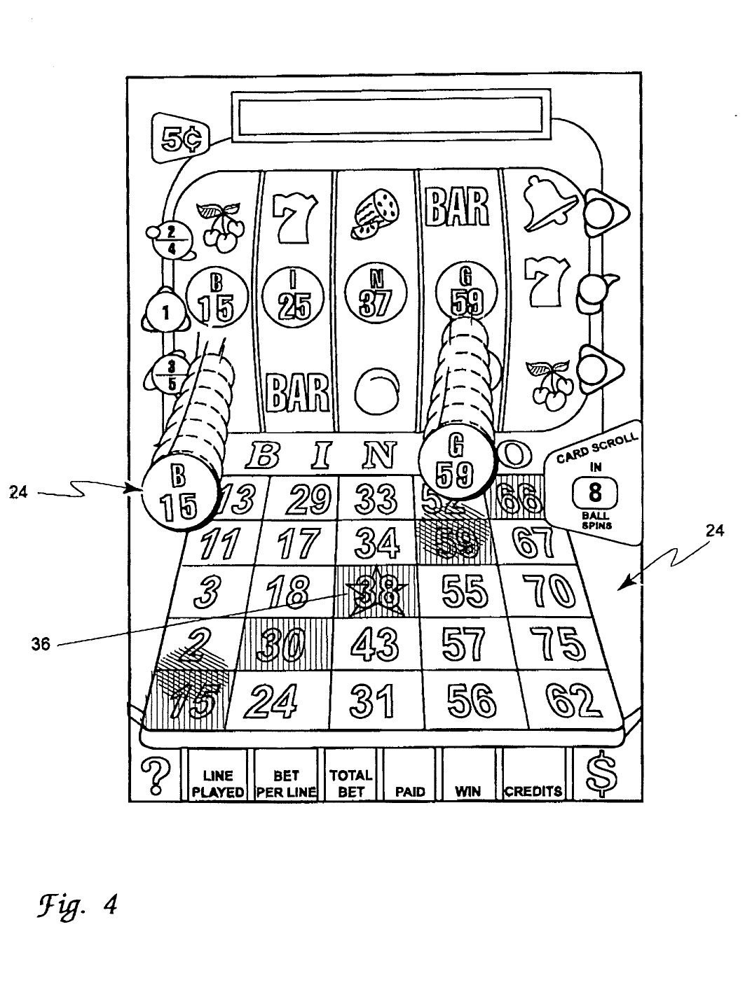

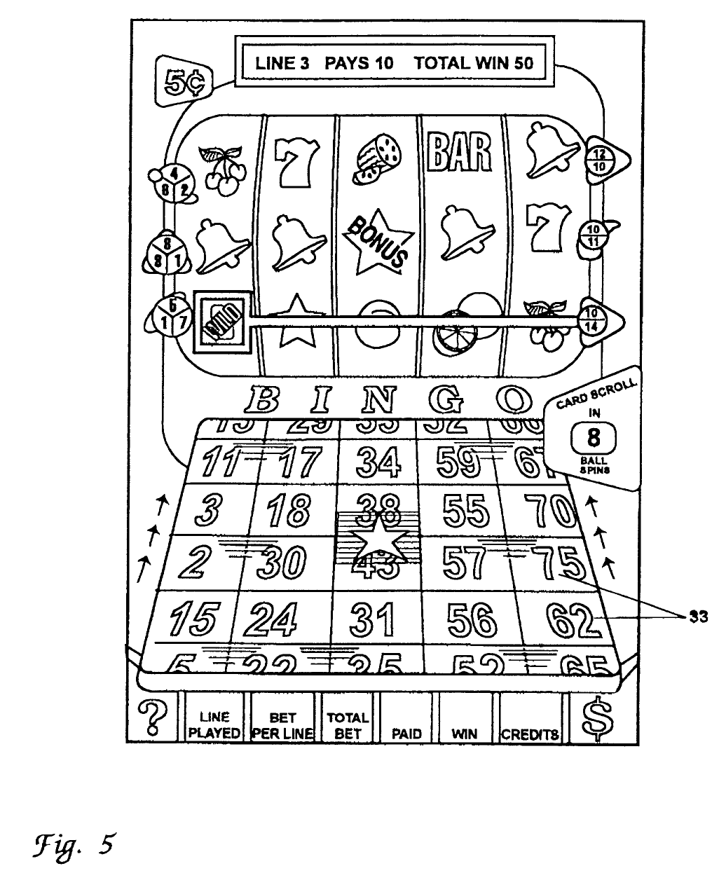

If the value displayed on the secondary indicium 24 matches a position 33 on the secondary game matrix 30, the indicium 24, or ball, travels from the primary game matrix 21 to the corresponding position 33 on the secondary game matrix 30, and that corresponding position 33 appears marked, or “covered.” The preferred embodiment features animated BINGO balls 24, that jump from the primary game to mark and “bounce” off of (covers) the corresponding position on the BINGO card, depicted in FIG. 4. This is roughly analogous to a “conventional” bingo game where a participant “daubs” (marks) a called number on a card. As the player continues play on the primary game, e.g., by making additional wagers, any enabled values on secondary indicia that appear are subsequently applied to the same secondary game. Play of the particular secondary game continues in this manner until a winning outcome appears on the secondary game matrix 30. As each value is revealed, it is removed from the pool of available values to be shown on subsequent BINGO balls 24. After a predetermined number of BINGO balls 24, preferably 12 or 15, have displayed values to the player, the rows on the BINGO card 30 “scroll up” one row, as shown in FIG. 5, wherein the top row disappears and a new bottom row appears. Thus, what heretofore was R₂ becomes R, and “old R”, vanishes. Similarly a “new R₅ appears and old R₅ becomes R₄, old R₄ becomes R₃, old R₃ becomes R₂. Any covered numbers that remain visible on the card 30 remain covered upon movement. Numbers corresponding to positions that disappear are returned to the pool of available values to be displayed on subsequent balls 24. All revealed values that did not match positions on the card 30 are also returned to the pool of available values at this time. The numbered position 33 that occupies the center space 36 at any given time is a “free” space. When a numbered position 33 moves into the center space 36, its number is “hidden,” but upon the next row movement, the number reappears and retains any marked or unmarked attribute it had prior to becoming the center space 36.

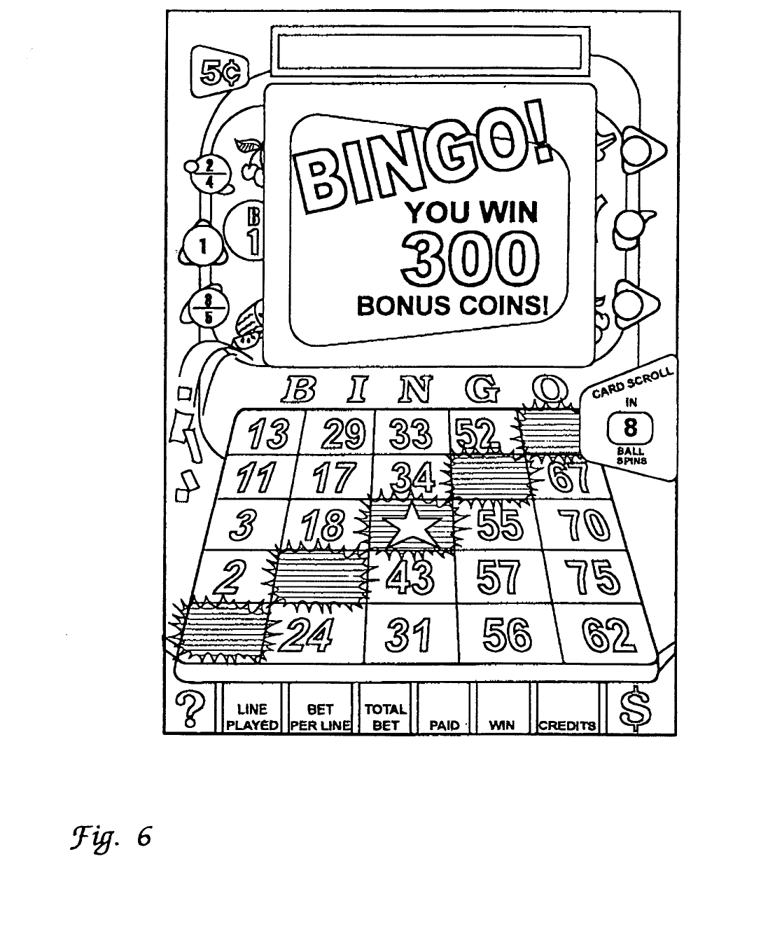

The preferred embodiment contemplates a winning outcome on a 5×5 BINGO matrix 30 to be five covered spaces in a row, either vertically, horizontally, or diagonally. If a winning outcome is achieved, such as that shown in FIG. 6, the player is awarded a randomly-determined number of credits, a special award screen is shown, and play continues.

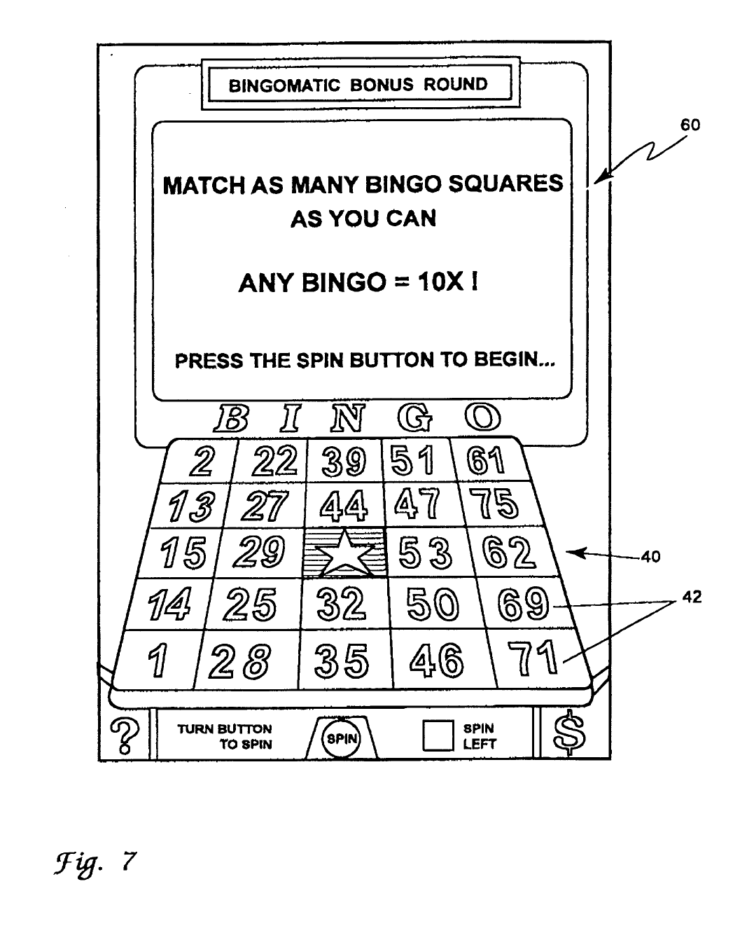

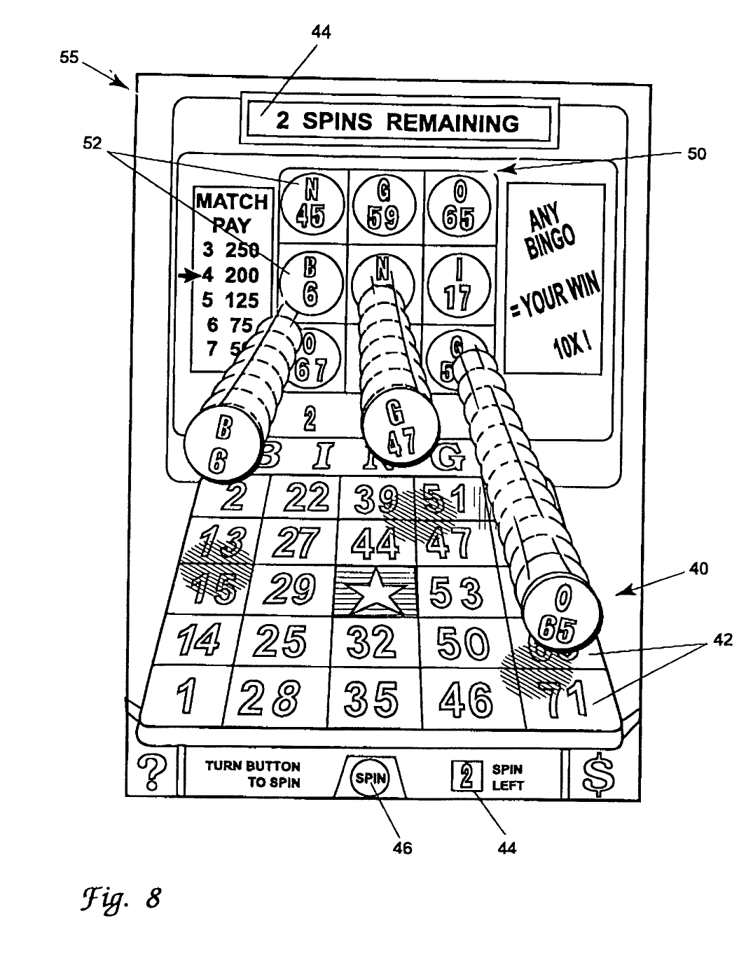

A separate bonus game, whose welcome screen 60 is depicted in FIG. 7, is activated by a special outcome on the primary game, such as three (or more) special symbols in a particular configuration or orientation. Upon activation, a bonus BINGO card 40 appears, which is preferably a 5×5 array with “BINGO” above the top row covering the BINGO card 30 from the earlier, secondary game. New randomly-numbered positions 42 appear on this bonus card 40, accompanied preferably by festive sound effects. In FIG. 8, the upper display area 55 is next covered by a matrix 50, preferably a 3×3 matrix, containing BINGO balls 52 of various colors, which correspond to the logo theme on the machine. The bonus display is depicted in FIG. 8. The player is awarded a randomly-generated number of “spins,” which is displayed on a counter 44. The player starts the bonus game by touching a “spin” button 46 on the display. All of the balls 52 in the matrix spin independently and then reveal a number or alphanumeric identifier. If any ball 52 matches a position on the card 40, the ball animates to mark, or “cover,” the corresponding position 42 by jumping from the matrix 50 to the bonus card 40 and “bouncing” on the corresponding position 42, as shown in FIG. 8. The spin counter 44 is then decremented. Play continues in this manner until all of the allotted spins are used. After the last spin is used, the player's award is totaled. The bonus award is calculated according to the number of covered spaces 42 on the bonus card 40. Multipliers may be applied to the award for traditional BINGO winning outcomes, such as a 2×multiplier for one BINGO, 5×for two BINGOs, and 10×for three or more BINGOs. Audio and video enhancements are provided concurrently with the awarding of credits. After credits are awarded, the bingo card from the primary game 30 is restored to its pre-bonus state, and the player is returned to the primary game.

In sum, a reel game exposes the player to a direct payout, and an opportunity to win by filling in a BINGO card below the reels. Symbols which fill the BINGO card come from the reels.

Not all BINGO symbols automatically transfer. At a minimum they must match. Optimally they are eligible (enabled) only upon wagers above minimum level. Preferably they are all enabled by a maximum bet. Assume a minimum bet entirely excludes the BINGO game. Assume a 2×minimum bet enables all BINGO Balls which are red. Assume a 3×minimum bet enables all red or blue BINGO Balls. Assume a 7×(maximum) bet enables all balls of other colors too (7=the total number of different colors). The incentive is maximum bet particularly when the BINGO card secondary display changes after a certain number of reel outcomes because the player now gets both multi line games and a multi “BALL” game. As above the bonus screen can follow a certain reel outcome (preferred) or BINGO outcome.

Moreover, having thus described the invention, it should be apparent that numerous structural modifications and adaptations may be resorted to without departing from the scope and fair meaning of the instant invention as set forth hereinabove and as described hereinbelow by the claims.

I claim:

1. A device for gaming, comprising, in combination:
a display,
a wagering means, and
a processor operatively coupled to said display and activated by said wagering means, said display when enabled including a primary game, said primary game including means for modifying said primary game during play and as a function of play.

2. The device of claim 1, further comprising a bonus event, activated by at least one outcome on said primary game.

3. The device of claim 2, wherein said primary game further includes a plurality of indicia having means for bestowing credits, said indicia categorized into classes, each said class having differing said credit-bestowing means associated with said class.

4. The device of claim 3 wherein at least one of said classes of indicia is always enabled.

5. The device of claim 4 wherein at least one of said classes of indicia is enabled only when a maximum input to said wagering means is employed.

6. The device of claim 5 wherein a plurality of said classes of indicia is enabled, directly related to the input of said wagering means.

7. The device of claim 6 wherein said indicia appear in a primary gaming event and are applied to a secondary gaming event to provide an outcome for the secondary gaming event.

8. The device of claim 7 wherein said secondary game is played on a row-and-column (RXC) matrix, said RXC matrix having randomly-numbered positions and rows R₁ . . . R_{N}.

9. The device of claim 8 wherein said indicia travel from said primary game to indicate matching positions on said RXC matrix if said indicia matches any of said randomly-numbered positions on said RXC matrix.

10. The device of claim 9 wherein said secondary game is modified after a predetermined number of said enabled indicia appear in said primary game.

11. The device of claim 10 wherein said modification includes shifting the positions of said RXC matrix, such that R₁ is omitted, R₂ becomes R₁, R₃ becomes R₂, . . . and a new row of randomly-numbered positions occupies R_{N}.

12. The device of claim 11 wherein said bonus event includes a bonus matrix having randomly-numbered positions.

13. The device of claim 12 wherein said bonus event includes a plurality of bonus indicia, arranged in an indicia matrix, said indicia having values representative of positions on said bonus matrix.

14. The device of claim 13 wherein said values on said bonus indicia are generated for a randomly-generated number of rounds.

15. The device of claim 14 wherein said bonus indicia travel from said indicia matrix to a matching position on said bonus matrix if said values match any of said randomly-numbered positions on said bonus matrix.

16. The device of claim 15 wherein an award is calculated according to the number of positions on said bonus matrix that match said indicia during all rounds of said bonus event.

17. The device of claim 16 wherein said award is modified by the presence of a subset of possible outcomes on said bonus matrix.

18. The device of claim 17 wherein said RXC matrix is restored to a pre-bonus-event state after termination of said bonus event.

19. The device of claim 17 wherein said RXC matrix is not restored to a pre-bonus-event state after termination of said bonus event.

20. A method for gaming, the steps including:
receiving a wager,
enabling a display upon receipt of the wager,
playing a primary game, said primary game having an outcome,
applying a subset of said primary game outcomes to a secondary game, and
modifying the play of said secondary game as a function of said primary game outcomes.

21. The method of claim 20, further including:
providing a plurality of indicia,
categorizing the indicia as a function of classes, and
bestowing on the classes different attributes leading to credits, whereupon during play the classes affect outcome.

22. The method of claim 21, further including:
triggering a bonus event upon the occurrence of at least one outcome of said primary game.
